(19) United States
(12) Patent Application Publication
(10) Pub. No.: US 2014/0343943 A1
(43) Pub. Date: Nov. 20, 2014

(54) Systems, Computer Medium and Computer-Implemented Methods for Authenticating Users Using Voice Streams

(71) Applicant: Saudi Arabian Oil Company, Dhahran (SA)

(72) Inventor: Essam A. Al-Telmissani, Dhahran Hills (SA)

(21) Appl. No.: 13/894,171

(22) Filed: May 14, 2013

(51) Int. Cl. G10L 17/00

(52) U.S. Cl. CPC G10L 17/00
USPC 704/246

(57) ABSTRACT

Provided are embodiments of systems, computer medium and computer-implemented methods for authenticating users using voice biometrics. Methods including receiving a request to access a resource via a user device, receiving a credentials set from a user (the credentials set including candidate credentials and candidate voice stream), determining whether the candidate credentials are valid based on a comparison of the candidate credentials to existing user credentials, in response to determining that the candidate credentials are valid, determining whether the candidate voice stream is valid based on a comparison of the candidate voice stream to a voice biometric associated with the candidate credentials and, in response to determining that the candidate voice stream is valid, generating an authentication signal configured to enable access to the resource via the user device.

### FIELD OF INVENTION

The present invention relates generally to authentication and more particularly to systems, machines, non-transitory computer medium having computer program instructions stored thereon, and computer-implemented methods for authentication using voice biometrics.

### BACKGROUND OF THE INVENTION

As technology has advanced, companies and other entities have placed a high reliance on network access to data and other resources. For example, many companies employ a data network that allows employs to remotely access resources using a client device, such as a computer workstation, a mobile device or the like. Resources may include, for example, electronic data, electronic documents, or the like. Such data network systems often employ some form of network security to prevent unauthorized access to resources. For example, a network security system may require authentication of a user prior to providing the user with access to a resource. A user may be required to provide credentials, such as a user name, personal identification number (PIN) or password, for example, to gain access to a resource. In some instances, a user may be required to present a physical token, such as swiping a magnetic card through a card reader, to gain access to a resource. In some instances the level of authentication may vary based on the nature of the resource to be accessed. For example, a user may be required to enter a PIN to access their voice mail, a user may be required to enter a user name and password to access their computer workstation, a user may be required to enter a code to enter a building, a user may be required to swipe an access card to access a critical area (e.g., a data center), and so forth.

Unfortunately, even with these types of security measures in place, the number of security breaches continues to grow. As a result, users may be able to obtain unauthorized access to resources and companies continue to spend a great deal of time and money in an effort to secure their resources.

### SUMMARY OF THE INVENTION

Applicant has recognized several shortcomings of existing network security systems and, in view of these shortcomings, has recognized the need for a centralized authentication system that can provide an increased level of security. Applicant has recognized that although existing network security systems provide some level of security, many systems do not employ the use of biometric characteristics that are unique to a user. For example, a security system may require a user provide credentials, such as a username and password that can be shared, stolen, or otherwise obtained and used by other users. Moreover, Applicant has recognized that existing systems which employ biometric characteristics that are unique to a user, such as a fingerprint, are complex and can require a substantial financial investment. For example, systems that require users to provide a fingerprint for authentication may require the use of a fingerprint scanner. Thus, existing network security systems fail to provide a framework for securing resources in a simple and cost effective manner. Applicant has recognized that such shortcomings have failed to be addressed by others, and has recognized that such shortcomings may be addressed by a system that can authenticate users using biometric characteristics that are unique to a user, such as voice biometrics, and that can be acquired using readily available hardware, such as a microphone. Such a system may reduce the overall complexity of an authentication system, while increasing security by using characteristics, such as voice biometrics, that are unique to a user. In view of the foregoing, various embodiments of the present invention advantageously provide systems, machines, non-transitory computer medium having computer program instructions stored thereon, and computer-implemented methods for authentication using voice biometrics.

In some embodiments, provided is a system for authenticating users using voice biometrics. The system includes a user device, a credential verification server and a voice verification server. The user device being operable to receive a request to access a resource, receive a credentials set from a user (the credentials set including candidate credentials and a candidate voice stream, transmit the candidate credentials to a credential verification server) and transmit the candidate voice stream to a voice verification server. The credential verification server being operable to receive the candidate credentials, determine whether the candidate credentials are valid based on a comparison of the candidate credentials to existing user credentials, and, in response to determining that the candidate credentials are valid, transmit a voice biometric associated with the candidate credentials to the voice verification server. The voice verification server being operable to receive the candidate voice stream and the voice biometric, determine whether the candidate voice stream is valid based on a comparison of the candidate voice stream to the voice biometric, and, in response to determining that the voice stream is valid, generate an authentication signal indicative of the user being authenticated. The user device being operable to provide access to the resource in response to the authentication signal.

In certain embodiments, the credential verification server is further operable to, in response to determining that the candidate credentials are invalid, and transmit a credentials invalid signal to the user device. The user device being operable to inhibit access to the resource based at least in part on the credentials invalid signal.

In some embodiments, the voice verification server is further operable to, in response to determining that the candidate voice stream is invalid, transmit a voice stream invalid signal to the user device. The user device being operable to inhibit access to the resource based at least in part on the voice stream invalid signal.

In certain embodiments, the user device is further operable to prompt the user to provide enrollment credentials and speak a vocal password, receive input of the enrollment credentials provided by the user, and acquire the vocal password spoken by the user. The enrollment credentials being stored in a credentials database as credentials for a user account associate with the user. A voice biometric is generated based on the vocal password, and the voice biometric being stored in a biometric database as a voice biometric for the user account associate with the user.

In some embodiments, the credentials are a user identifier. In certain embodiments a voice biometric for a user includes a voiceprint based on a recording of the user's speech. In some embodiments, the resource includes an electronic document, and/or access to a user device, access to an electronic signature function. In certain embodiments, the user device includes and electronic lock and the resource includes opening of the lock to provide physical access to a physical location.

In some embodiments, provided is computer-implemented method for authenticating users using voice biometrics. The method including receiving a request to access a resource via a user device, receiving a credentials set from a user (the credentials set including candidate credentials and candidate voice stream), determining whether the candidate credentials are valid based on a comparison of the candidate credentials to existing user credentials, in response to determining that the candidate credentials are valid, determining whether the candidate voice stream is valid based on a comparison of the candidate voice stream to a voice biometric associated with the candidate credentials and, in response to determining that the candidate voice stream is valid, generating an authentication signal to enable access to the resource via the user device.

In certain embodiments, provided is a non-transitory computer readable storage medium having program instructions stored thereon that are executable by one or more processors to cause the following steps for authenticating users using voice biometrics: receiving a request to access a resource via a user device, receiving a credentials set from a user (the credentials set including candidate credentials and candidate voice stream), determining whether the candidate credentials are valid based on a comparison of the candidate credentials to existing user credentials, in response to determining that the candidate credentials are valid, determining whether the candidate voice stream is valid based on a comparison of the candidate voice stream to a voice biometric associated with the candidate credentials and, in response to determining that the candidate voice stream is valid, generating an authentication signal to enable access to the resource via the user device.

Accordingly, as described herein, embodiments of the system, computer program instructions and associated computer-implemented methods provide for user authentication using voice biometrics.

### BRIEF DESCRIPTION OF THE DRAWINGS

FIG. 1 is a diagram that illustrates a secure data network system in accordance with one more embodiments of the present invention.

FIG. 2 is a block diagram that illustrates components of a user device in accordance with one or more embodiments of the present invention.

FIG. 3 is a block diagram that illustrates components of a credential verification server in accordance with one or more embodiments of the present invention.

FIG. 4 is a block diagram that illustrates components of a voice verification server in accordance with one or more embodiments of the present invention.

FIG. 5 is a block diagram that illustrates components of a resource server in accordance with one or more embodiments of the present invention.

FIG. 6 is a block diagram that illustrates operations of an authentication system in accordance with one more embodiments of the present invention.

FIG. 7 is a flow diagram that illustrates operations of an authentication system in accordance with one more embodiments of the present invention.

FIGS. 8A and 8B are flowcharts that illustrate methods of processing a resource request in accordance with one or more embodiments of the present invention.

FIG. 9 is a flowchart that illustrates a method of credential verification/validation in accordance with one or more embodiments of the present invention.

FIG. 10 is a flowchart that illustrates a method of voice stream verification/validation in accordance with one or more embodiments of the present invention.

While the invention is susceptible to various modifications and alternative forms, specific embodiments of the invention are shown by way of example in the drawings and will be described in detail herein. It should be understood, however, that the drawings and detailed description thereof are not intended to limit the invention to the particular form disclosed, but to the contrary, are intended to cover all modifications, equivalents, and alternatives falling within the spirit and scope of the present invention as defined by the appended claims.

### DETAILED DESCRIPTION

The present invention will now be described more fully hereinafter with reference to the accompanying drawings in which exemplary embodiments of the invention are shown. This invention may, however, be embodied in many different forms and should not be construed as limited to the illustrated embodiments set forth herein, rather, these exemplary embodiments are provided so that this disclosure will be thorough and complete, and will fully convey the scope of the invention to those skilled in the art.

In some embodiments, provided is an authentication system that employs user credentials and biometric characteristics to authenticate users, that grants or denies access to various network resources based on authentication of users, and that employs readily available hardware, such as a microphone, to acquire biometric characteristics used to authenticate users. Such an authentication system may provide enhanced network security in an efficient and cost effective manner.

In certain embodiments, a user is authenticated based at least in part on user credentials and/or a voice biometric provided by the user. For example, upon requesting access to a resource, such as requesting to open a file, the user may be prompted to enter their credentials, such as their user name, and to say a given word or phrase, such as their password (i.e., a “vocal password”). The spoken password may be recorded as a voice stream. The credentials and the voice stream may be compared to existing credentials and exiting voice biometrics, respectively, to authenticate the user. For example, the user name may be compared against user names for existing user profiles to verify/validate the user name (e.g., to determine whether the user name matches an existing user name associated with a user profile/account), and the voice stream may be compared to an existing voice biometric for the user profile, such as a pre-recorded audio file of the user speaking the password or a voice print generated therefrom, to verify/validate the voice stream (e.g., to determine whether a voiceprint the voice stream is consistent with the voiceprint). If both of the credentials and the voice stream are verified/validated, the user may be authenticated and, thus, may be provided access to the resource. For example, where the user request access to an electronic document via a workstation, and the user is authenticated (e.g., the submitted credentials and voice stream are verified/validated), the workstation may retrieve the document from a server and display it to the user. In contrast, where the user is not authenticated (e.g., the submitted credentials or voice stream are invalid), the workstation may not retrieve the document from the server and/or may not display it to the user. That is, an authenticated user may be provided access to a requested resource, and an unauthenticated user may not be provided access to the requested resource.

In some embodiments, a secure data network includes user devices, an authentication system and a resource system. User devices may include, for example, a computer workstation, a mobile device (e.g., a smart phone), or the like. An authentication system may include, for example, servers that verify user credentials and/or voice streams to authenticate users. In some embodiments, an authentication system includes a credential verification server that performs verification/validation of user credentials and a voice verification server that performs verification/validation of voice streams. Although certain embodiments describe these as independent servers for the purpose of illustration, embodiments may include these operations being provided by any number and variety of devices. For example, a single server may perform verification/validation of credentials and voice streams. Resource systems may include data servers or the like, that serve, or otherwise provide access to, electronic resources.

In certain embodiments, a secure data network obtains user credentials and a voice stream from a user, performs verification/validation of the credentials and the voice stream to authenticate the user and, after authenticating the user, provides the user with access to a resource. For example, the user Mike Smith may access a network drive on his computer workstation and request to open an electronic document entitled “report.doc”. In response to the request and a determination that access to the document requires user authentication, the user device may display a prompt requesting Mike Smith to enter his user name and “speak” his password into a microphone of the computer workstation. Mike Smith may enter his user name “msmith” into a user name field displayed on the workstation, and speak his password “chocolate” into a microphone of the workstation. The secure data network may process the user name and the spoken password to authenticate Mike Smith as the user and, only after authenticating Mike Smith as the user will the workstation provide Mike Smith with access to “report.doc”.

In some embodiments, authentication includes a distributed process that is performed by multiple entities of a secure data network. For example, a user device may be employed to acquire a candidate credentials dataset (e.g., including candidate credentials and a candidate voice stream submitted by the user), a credential verification server may be used to verify/validate the candidate credentials, and a voice verification server may be used to verify/validate the candidate voice stream. Such a distributed system may enhance performance by allowing verification/validation processes to be offloaded to different entities. In some embodiments, the process flow of authentication may reduce processing loads by performing voice verification/validation only after the user's credentials are verified/validated. Moreover, the modular nature of the system embodiments may enable distribution of tasks to systems that are specially adapted for performing the specific functions. For example, a voice verification server that is particularly well suited for performing voice verifications can be integrated into an existing authentication system using the techniques described herein to add voice verification to an authentication process.

In some embodiments, the user device forwards the candidate credentials to a credential verification server for verification/validation, and forwards the candidate voice stream to a voice verification server for verification/validation. For example, the workstation may forward the string “msmith” to a credential verification server for verification/validation, and forward audio data including the recording of “chocolate” (as spoken by Mike Smith) to a voice verification server for verification/validation. The credential verification server may verify/validate the candidate credentials by comparing them to existing credentials. For example, the credential verification server may compare the user name “msmith” against user names for existing/active user profiles/accounts stored in a credentials database to determine whether the user name “msmith” is valid (e.g., matches an existing user name associated with a user profile). If the candidate credentials are verified/validate, the voice verification server may, then, verify/validate the candidate voice stream by comparing the candidate voice stream to an existing voice stream associated with the credentials. For example, if it is determined that the user name “msmith” is valid, the credential verification server may transmit a signal to the voice verification server indicating that the user name “msmith” is valid (e.g., a credential valid signal), and the voice verification server may, then, compare the candidate voice stream (e.g., the audio data including the recording of “chocolate” as spoken by Mike Smith) to a voice biometric associated with the user profile for “msmith” to determine whether or not the voice stream is valid. The existing voice biometric may include a voiceprint generated based on a recording of words and/or phrases spoken by the user associated the user account. For example, the existing voice biometric may include a voice print generated based on a prior recording of Mike Smith speaking his password “chocolate”. This may have been done, for example, when Mike Smith previously enrolled in his user profile/account, or the last time he reset his vocal password.

In some instances, the biometric data that is used to verify/validate the candidate voice stream is provided by the credential verification server. For example, upon determining that the user name “msmith” is valid, the credential verification server may retrieve the existing voice biometric for the user account associated with “msmith” from a biometric database, and transmit the existing voice biometric to the voice verification server (e.g., in addition to or in place of the credential valid signal). In some instances, the biometric data that is used to verify/validate the candidate voice stream is retrieved by the voice verification server. For example, upon receiving the credential valid signal indicating that “msmith” is a valid user name, the voice verification server may retrieve the existing voice biometric for the user account associated with “msmith” from the biometric database.

The comparison of the candidate voice stream to the existing voice biometric may include comparing the content of the voice stream (e.g., what was said) and/or the biometric characteristics of the voice stream (e.g., how it was said) corresponding content or characteristics of the existing voice biometric. In some instances, the candidate voice stream may be verified when the content and/or the biometric characteristics of the candidate voice stream are verified/validated against the existing voice biometrics. For example, the candidate voice stream may be verified if the existing voice biometric and the candidate voice stream both include a recording of, or otherwise include characteristics of, Mike Smith saying the word “chocolate” in a similar manner. In contrast, the candidate voice stream may not be verified if the existing voice biometric includes a recording of (or a voice print corresponding to) Mike Smith saying the word “chocolate” and the candidate voice stream includes a recording of Mike Smith saying the word “chocolate” in a different manner (e.g., in a different tone of voice), Mike Smith saying a word other than “chocolate” (e.g., Mike Smith saying “strawberry”), or a recording of another user's voice (e.g., Jane White saying the word “chocolate”).

In some embodiments, the comparison of the candidate voice stream to the existing voice stream is provided by a voice biometric engine. A voice biometric engine may include a collection of software functions that processes audio samples, extracts relevant vocal information (or features), and creates a unique and representative model of the original speech. During an enrollment process, a voice biometric engine may extract vocal features from one or more speech samples (e.g., existing voice streams) to create a voiceprint. During a verification process, the voice biometric engine may extract vocal features from a sample (e.g., a candidate voice stream), compare the features to a stored voiceprint, and then generate a score or match probability. If the score or match probability satisfies (e.g., meets or exceeds) a predetermined threshold, the identity of the speaker and/or the content of the candidate voice stream may be verified. If the score or match probability does not satisfy (e.g., is below) a predetermined threshold, the identity of the speaker and/or the content of the candidate voice stream may not be verified.

In some embodiments, during an enrollment process a user may be prompted to provide an enrollment credential and/or speak a vocal password. For example, Mike Smith may be prompted by his workstation to provide his user name and password. The enrollment credential may be received and the vocal password may be acquired via the workstation. In some embodiments, the enrollment credential is stored in a credentials database as a credential for a user account associate with the user. In some embodiments, a voice biometric for the user is generated based on an audio recording (e.g., the voice stream) of the user speaking the vocal password. The voice biometric and/or the voice stream may be stored in a biometric database as a voice biometric for the user account associated with the user. For example, where Mike Smith enters his user name “msmith” and says his password “chocolate”, the user name “msmith” may be associated and a voiceprint (or similar voice biometric) of Mike Smith saying his password “chocolate” may be associated with Mike Smith's user account.

If it is determined that the candidate voice stream is not valid (e.g., the submitted voice stream does correspond to the existing voice biometric), access to the resource may be denied. For example, if the submitted voice stream is determined to be invalid, Mike Smith may be denied access to “report.doc”. In such an instance, the voice verification server may transmit a signal to the workstation indicating that the voice stream is invalid (e.g., a voice stream invalid signal and/or an authentication status signal indicating the user is not authenticated). In response to the signal indicating the voice stream is invalid and, thus, indicating that the user is not authenticated, the workstation may continue to deny access to the resource. For example, the workstation may continue to deny access to “report.doc”, and may display a notification that access was denied along with a prompt for the user to re-enter a valid user name and speak a valid password into a microphone of the computer workstation.

If it is determined that the candidate voice stream is valid (e.g., the submitted voice stream does correspond to the existing voice biometric), access to the resource may be granted. In such an instance, the voice verification server may transmit a signal to the workstation indicating that the voice stream is valid (e.g., a voice stream valid signal and/or an authentication status signal indicating the user is authenticated). In response to the signal indicating the voice stream is valid and/or the user being authenticated, the workstation may provide access to “report.doc”. For example, the workstation may retrieve “report.doc” from a document server and display the document for review/editing by the user.

Although certain embodiments are described with regard to accessing an electronic document resource from a computer workstation for the purpose of illustration, the techniques described herein can be applied to any variety of embodiments, including various types of resources and various types of user devices. In some embodiments, a requested resource may include access to a network, a computer system, a user device, or the like. For example, upon attempting to log-on to a network, computer system, user device, or the like, the user may be prompted to enter credentials (e.g., their user name, PIN, secret code, or a similar identifier) and to speak an identifying sound (e.g., words, phrases, their password, or the like) to verify their identity, and, if the credentials and the spoken sounds are verified/validated, the user may authenticated and may be granted access to the network, computer system, user device, or the like. In some embodiments, a requested resource may include access to particular programs, operations, or the like. For example, upon attempting to electronically sign (“e-sign”) a document, the user may be prompted to enter credentials (e.g., their user name, PIN, secret code, or a similar identifier) and to speak an identifying sound (e.g., words, phrases, their password, or the like) to verify their identity, and, if the credentials and the spoken sounds are verified/validated, the user may authenticated and may be granted the ability to e-sign documents using an e-signature corresponding to the authenticated user. In some embodiments, a requested resource may include access to physical location secured by a physical locking device. For example, upon attempting to open a digital door lock that inhibits access to a room or other space, the user may be prompted to enter credentials (e.g., their user name, PIN, secret code, or similar identifier) and to speak an identifying sound (e.g., words, phrases, their password, or the like) to verify their identity, and, if the credentials and the spoken sounds are verified/validated, the user may authenticated and the lock may be opened such that the user can enter the room or other space.

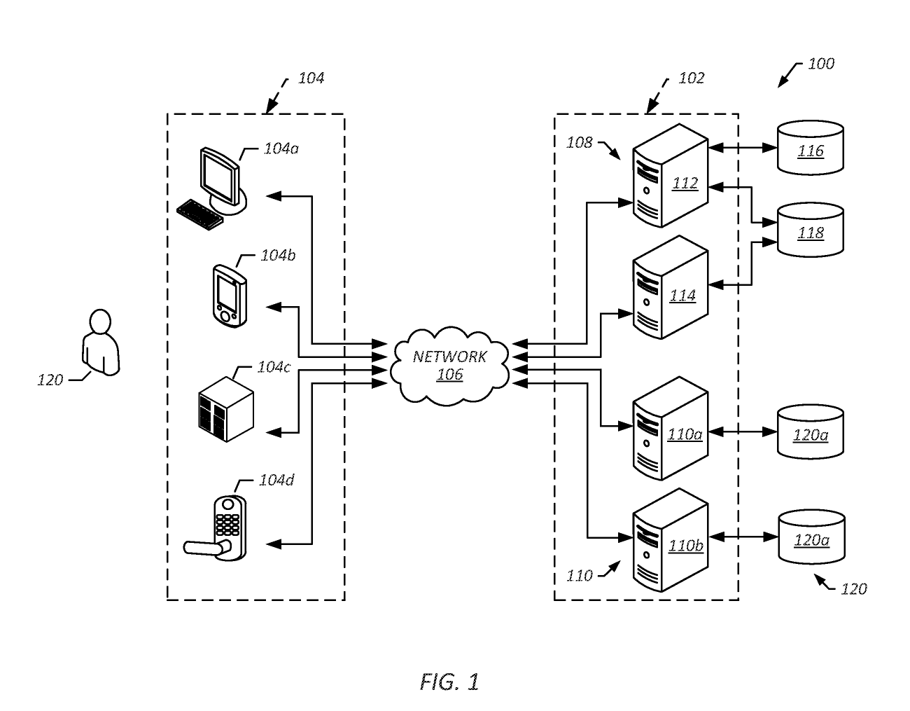

FIG. 1 is a diagram that illustrates a secure data network system (“data network”) 100 in accordance with one more embodiments of the present invention. Data network 100 includes network servers 102 and user devices 104 communicatively coupled via a communications network (“network”) 106. Network servers 102 may include one or more authentication servers 108 and one or more resource servers 110 (e.g., servers 100a and 110b). Authentication servers 108 may include a credential verification server 112 and a voice verification server 114. Credential verification server 112 may have access to a credentials database 116. Credential verification server 112 and/or voice verification server may have access to a biometric database 118. Resource servers 110 may have access to one or more resource databases 120 (e.g., databases 120a and 120b).

Network 106 may include an element or system that facilitates communication between entities of data network 100. For example, network 106 may include an electronic communications network, such as the Internet, a local area network (“LAN”), a wide area (“WAN”), a wireless local area network (“WLAN”), a cellular communications network, and/or the like. In some embodiments, network 106 includes a single network or combination of networks.

User devices 104 may include any variety of mobile electronic devices. For example, devices 104 may include desktop computers, laptop computers, tablet computers, cellular phones, personal digital assistants (PDAs), or the like. In the illustrated embodiment, user devices 104 include a desktop computer (e.g., an employee workstation) 104a, a mobile electronic device (e.g., a network enabled smart phone) 104b, an interactive voice response/voice over Internet Protocol (IVR/VOIP) device 104c, and a location access device (e.g., an electronic door lock) 104d.

User devices 104 may include various input/output (I/O) interfaces, such as a graphical user interface (e.g., a display screen), an image acquisition device (e.g., a camera), an audible output user interface (e.g., a speaker), an audible input user interface (e.g., a microphone), a keyboard/keypad, a pointer/selection device (e.g., a mouse, a trackball, a touchpad, a touchscreen, a stylus, etc.), a printer, or the like. In some embodiments, user devices 104 include general computing components and/or embedded systems optimized with specific components for performing specific tasks. User devices 104 may include applications/modules having program instructions that are executable by a computer system to perform some or all of the functionality described herein with regard to the respective devices 104.

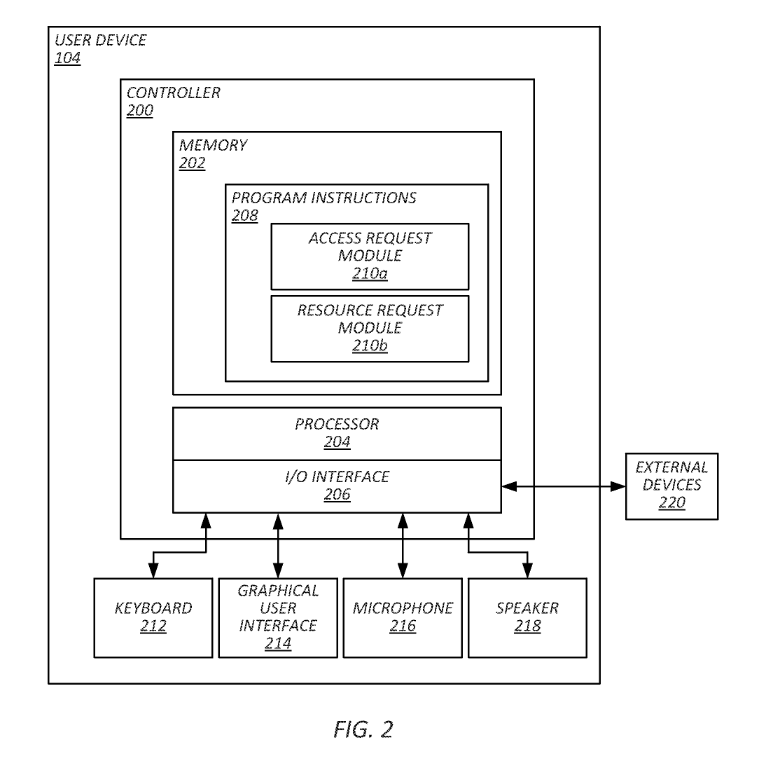

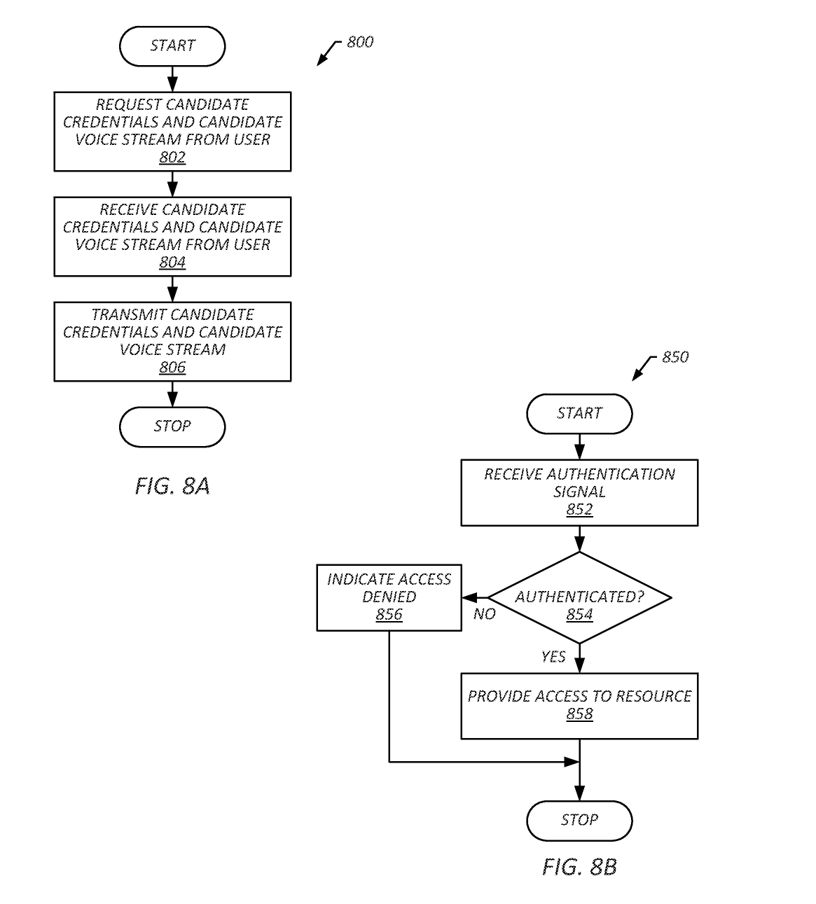

FIG. 2 is a block diagram that illustrates components of a user device 104 in accordance with one or more embodiments of the present invention. In some embodiments, user device 104 includes a controller 200 for controlling the operational aspects of user device 104. In some embodiments, controller 200 includes a memory 202, a processor 204 and an input/output (I/O) interface 206. Memory 202 may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. Memory 202 may include a non-transitory computer readable storage medium having program instructions 208 stored thereon that are executable by a computer processor (e.g., processor 204) to cause the functional operations (e.g., methods/routines/processes) described herein with regard to user device 104. Program instructions 208 may include modules including program instructions that are executable by processor 204 to provide some or all of the functionality described herein with regard to user device 104. Program instructions 208 may include an access request module 210a for performing some or all of the operational aspects of method 800 (described in more detail below wither regard to FIG. 8A) and/or a resource request module 210b for performing some or all of the operational aspects of method 850 (described in more detail below wither regard to FIG. 8B).

Processor 204 may be any suitable processor capable of executing/performing program instructions. Processor 204 may include a central processing unit (CPU) that carries out program instructions (e.g., program instructions of modules 210a and/or 210b) to perform arithmetical, logical, and input/output operations of user device 104, including those described herein. I/O interface 206 may provide an interface for communication with of one or more I/O devices of user device 104 and/or external devices 220. I/O devices may include a keyboard 212, a graphical user interface (GUI) 214, a microphone 216, a speaker 218, and/or the like. External devices 220 may include network servers 102. I/O devices and external devices may be connected to I/O interface 206 via a wired or wireless connection (e.g., via network 106).

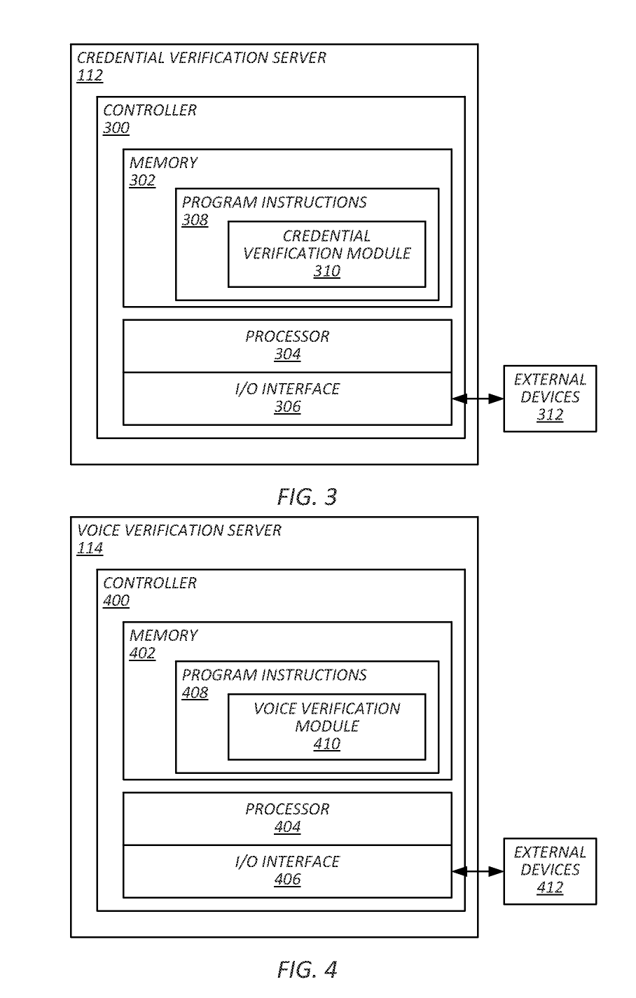

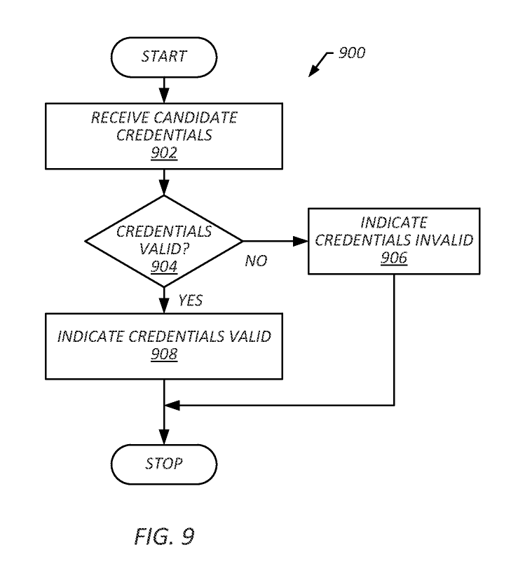

FIG. 3 is a block diagram that illustrates components of a credential verification server 112 in accordance with one or more embodiments of the present invention. In some embodiments, credential verification server 112 includes a controller 300 for controlling the operational aspects of credential verification server 112. In some embodiments, controller 300 includes a memory 302, a processor 304 and an input/output (I/O) interface 306. Memory 302 may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. Memory 302 may include a non-transitory computer readable storage medium having program instructions 308 stored thereon that are executable by a computer processor (e.g., processor 304) to cause the functional operations (e.g., methods/routines/processes) described herein with regard to credential verification server 112. Program instructions 308 may include modules including program instructions that are executable by processor 304 to provide some or all of the functionality described herein with regard to credential verification server 112. Program instructions 308 may include a credential verification module 310 for performing some or all of the operational aspects of method 900 (described in more detail below wither regard to FIG. 9).

Processor 304 may be any suitable processor capable of executing/performing program instructions. Processor 304 may include a central processing unit (CPU) that carries out program instructions (e.g., program instructions of module 310) to perform arithmetical, logical, and input/output operations of credential verification server 112, including those described herein. I/O interface 206 may provide an interface for communication with of one or more I/O devices and/or external devices 312. I/O devices may include a keyboard, a graphical user interface, a microphone, a speaker, and/or the like. External devices 312 may include other network servers 102, user devices 104, credentials database 116, biometric database 118, databases 120, and/or the like. I/O devices and external devices may be connected to I/O interface 206 via a wired or wireless connection (e.g., via network 106).

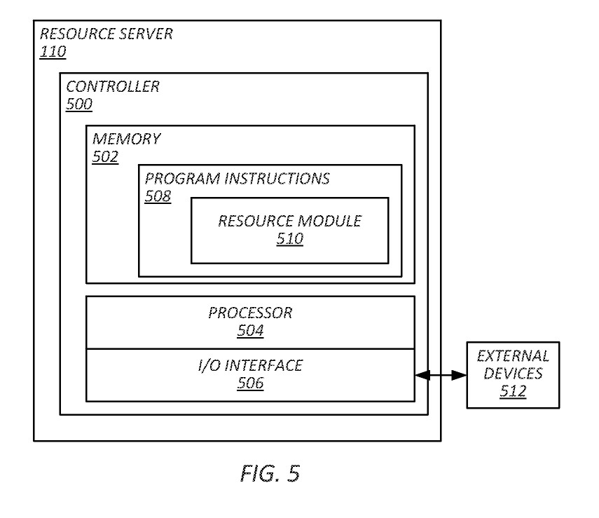

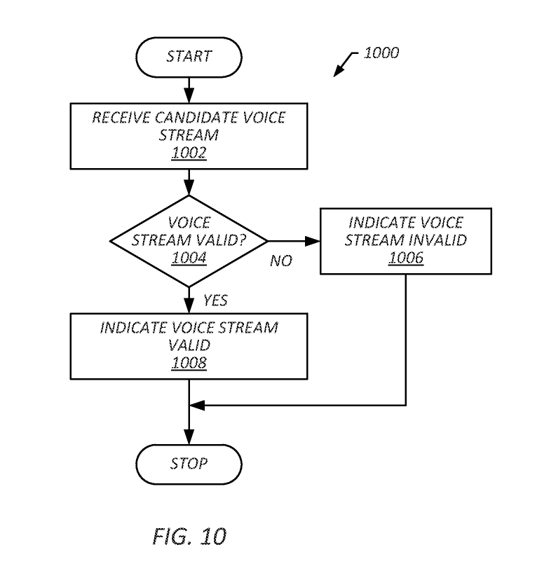

FIG. 4 is a block diagram that illustrates components of a voice verification server 114 in accordance with one or more embodiments of the present invention. In some embodiments, voice verification server 114 includes a controller 400 for controlling the operational aspects of voice verification server 114. In some embodiments, controller 400 includes a memory 402, a processor 404 and an input/output (I/O) interface 406. Memory 402 may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. Memory 402 may include a non-transitory computer readable storage medium having program instructions 408 stored thereon that are executable by a computer processor (e.g., processor 404) to cause the functional operations (e.g., methods/routines/processes) described herein with regard to voice verification server 114. Program instructions 408 may include modules including program instructions that are executable by processor 404 to provide some or all of the functionality described herein with regard to voice verification server 114. Program instructions 408 may include a voice verification module 410 for performing some or all of the operational aspects of method 1000 (described in more detail below wither regard to FIG. 10).

Processor 404 may be any suitable processor capable of executing/performing program instructions. Processor 404 may include a central processing unit (CPU) that carries out program instructions (e.g., program instructions of module 410) to perform arithmetical, logical, and input/output operations of voice verification server 114, including those described herein. I/O interface 406 may provide an interface for communication with of one or more I/O devices and/or external devices 412. I/O devices may include a keyboard, a graphical user interface, a microphone, a speaker, and/or the like. External devices 412 may include other network servers 102, user devices 104, credentials database 116, biometric database 118, databases 120, and/or the like. I/O devices and external devices may be connected to I/O interface 406 via a wired or wireless connection (e.g., via network 106).

FIG. 5 is a block diagram that illustrates components of a resource server 110 in accordance with one or more embodiments of the present invention. In some embodiments, resource server 110 includes a controller 500 for controlling the operational aspects of resource server 110. In some embodiments, controller 500 includes a memory 502, a processor 504 and an input/output (I/O) interface 506. Memory 502 may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. Memory 502 may include a non-transitory computer readable storage medium having program instructions 508 stored thereon that are executable by a computer processor (e.g., processor 504) to cause the functional operations (e.g., methods/routines/processes) described herein with regard to resource server 110. Program instructions 508 may include a resource module 510 including program instructions that are executable by processor 504 to provide/perform some or all of the functionality described herein with regard to resource server 110.

Processor 504 may be any suitable processor capable of executing/performing program instructions. Processor 504 may include a central processing unit (CPU) that carries out program instructions (e.g., program instructions of module 510) to perform arithmetical, logical, and input/output operations of resource server 110, including those described herein. I/O interface 506 may provide an interface for communication with of one or more I/O devices and/or external devices 512. I/O devices may include a keyboard, a graphical user interface, a microphone, a speaker, and/or the like. External devices 512 may include other network servers 102, user devices 104, credentials database 116, biometric database 118, databases 120, and/or the like. I/O devices and external devices may be connected to I/O interface 506 via a wired or wireless connection (e.g., via network 106).

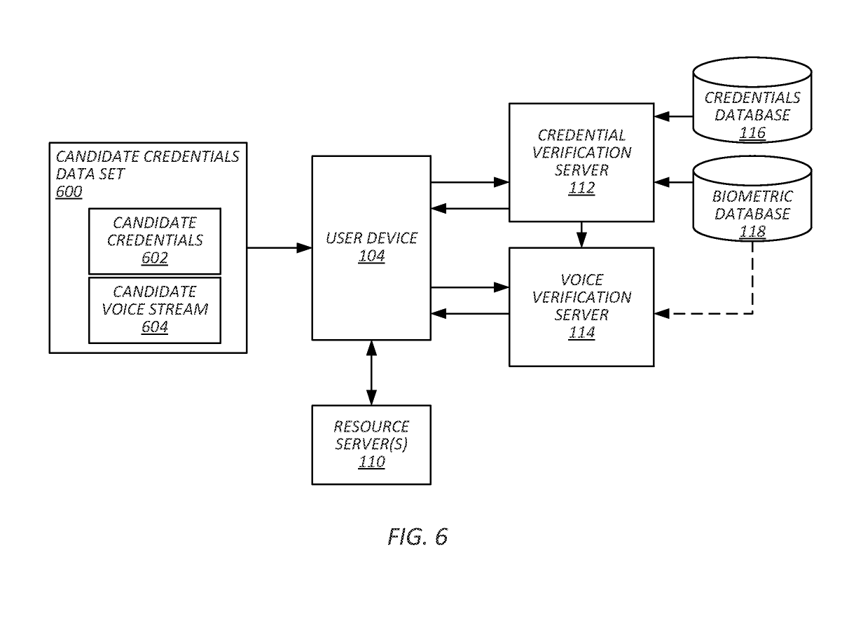

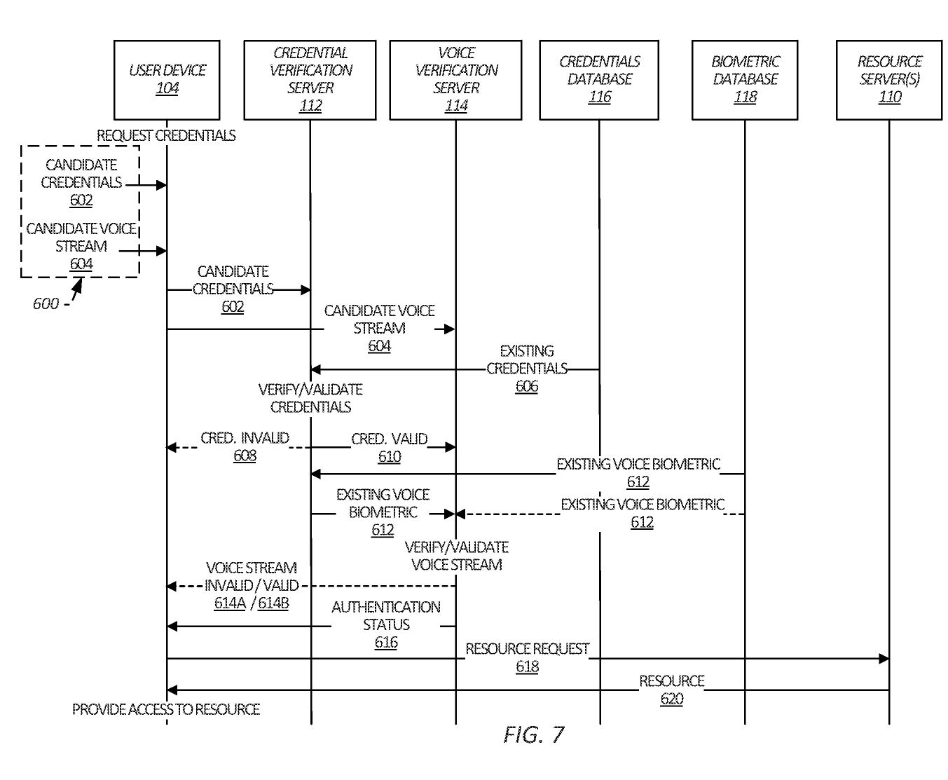

FIG. 6 is a block diagram that illustrates operations of an authentication system in accordance with one more embodiments of the present invention. FIG. 7 is a flow diagram that illustrates operations of an authentication system in accordance with one more embodiments of the present invention. In some embodiments, a user device 104 (e.g., user device 104a, 104b, 104c, or 104d) acquires a candidate credentials dataset 600, including candidate user credentials (“candidate credentials”) 602 and a candidate user voice stream (“candidate voice stream”) 604. Candidate credentials 602 may include, for example, a user name, PIN, secret code or similar identifier. Candidate credentials for the user Mike Smith, for example, may include his user name “msmith”. In some embodiments, Candidate credentials may be provided by a user physical entering the data (e.g., typing the data in using a keyboard, touch screen, keypad or the like), speaking the data into a voice recognition device (e.g., speaking the data into an interactive voice response/voice over Internet Protocol (IVR/VOIP) device or the like), presenting a physical access token (e.g., swiping a magnetic strip of an ID/access card though a card reader or the like), and/or the like. A candidate voice stream 604 may include, for example, audible data corresponding to word(s), phrase(s), or other sounds spoken by a user. A candidate voice stream 604 for the user Mike Smith may include audio data corresponding to his speaking his vocal password “chocolate”. A candidate voice stream may include audio data that can be used to verify the identity of the user that provided the voice stream. For example, as described herein the audio data of a candidate voice stream (e.g., a candidate voiceprint) may be compared to biometric data for the user (e.g., a known/existing voiceprint for the user's vocal password) to verify that the candidate voice stream was in fact spoken by the user and/or includes a required word/phrase/sound. In some embodiments, candidate credentials 602 and voice stream 604 are provided by a user via an I/O interface of user device 104. For example, user 120 may enter candidate credentials 602 using a keyboard, keypad, touchscreen, voice recognitions devices, or the like of user device 104. Voice stream 604 may be provided by the user speaking into an audio recording device, such as a microphone, of user device 104.

In some embodiments, a user is requested to provide candidate credentials 602 and a candidate voice stream 604. For example, in response to a user requesting access to a resource, user device 104 may prompt the user to provide their credentials and a voice stream. In response to receiving Mike Smith's request to open an electronic document entitled “report.doc”, for example, user device 104 may display a prompt requesting Mike Smith to enter a user name and “speak” his vocal password into a microphone of user device 104.

In some embodiments, user device 104 forwards candidate credentials 602 and/or candidate voice stream 604 to one or more entities of system 100 for use in authenticating the user. For example, user device 104 may forward candidate credentials 602 to credential verification server 112 and/or forward candidate voice stream 604 to voice verification server 114. User device 104 may, for example, forward the string “msmith” to credential verification server 112 for verification/validation, and/or forward candidate voice stream 604 including the recording of “chocolate” (as spoken by Mike Smith) to voice verification server 114 for verification/validation.

Credential verification server 112 may compare candidate credentials 602 to existing credentials 606. For example, where credentials database 116 includes a listing of all existing/active user credentials, credential verification server 112 may query credentials database 116 for a listing of all existing user credentials 606, and may determine whether candidate credentials 602 matches any existing user credentials 606. Credential verification server 112 may, for example, retrieve a list of user names associated with current/active user accounts from credentials database 116, and determine whether the candidate user name “msmith” matches an existing user name associated with current/active user account. The candidate credentials may be verified/validated if the candidate credentials matches an existing credential. For example, the candidate user name “msmith” may be verified/validated if the user name “msmith” is associated with a current/active user account (e.g., Mike Smith's user account). Candidate credentials 602 may not be verified/validated if the candidate credentials does not match an existing credential. For example, the candidate user name “msmith” may not be verified/validated if the user name “msmith” is not associated with a current/active user account (e.g., a user account for Mike Smith's does not exists or is de-activated).

If candidate credentials 602 are not validated/verified, credential verification server 112 may provide an indication that candidate credentials 602 are invalid. In some embodiments, in response credential verification server 112 determining that candidate credentials 602 are invalid, credential verification server 112 transmits a credential invalid signal 608 to user device 104. For example, in response to credential verification server 112 determining that the user name “msmith” is invalid, credential verification server 112 may transmit a corresponding credentials invalid signal 608 to user device 104. Credentials invalid signal 608 may indicate that candidate credentials 602 are not verified/valid and, thus, the user is not authenticated.

In response to receiving credentials invalid signal 608, user device 104 may continue to deny access to the resource and provide a corresponding notification to user 120. For example, in response to receiving credential invalid signal 608, user device 104 may continue to deny access to “report.doc”, and may display a notification that access was denied along with a prompt for the user to re-enter a valid user name and speak a valid password into a microphone of user device 104.

If candidate credentials 602 are validated/verified, credential verification server 112 may provide a corresponding indication that candidate credentials 602 are verified/valid. In some embodiments, in response credential verification server 112 determining that candidate credentials 602 are verified/valid, credential verification server 112 transmits a credential valid signal 610 to voice verification server 114. For example, in response to credential verification server 112 determining that the user name “msmith” is verified/valid, credential verification server 112 may transmit a corresponding credentials valid signal 610 to voice verification server 114. Credentials valid signal 610 may indicate that candidate credentials 602 are verified/valid.

In some embodiments, voice verification server 114 proceeds to verifying/validating candidate voice stream 604 in response to receiving credentials valid signal 610. Accordingly, in some embodiments, the authentication process may proceed to verifying/validating candidate voice stream 604 only after verifying/validating candidate credentials 602.

In some embodiments, verifying/validating candidate voice stream 604 includes comparing candidate voice stream 604 to an existing voice biometric 612 associated with the verified/validated candidate credentials 602. For example, voice verification server 114 may receive/retrieve a voice biometric 612 corresponding to the verified/validated candidate credentials 602, and compare one or more characteristics of candidate voice stream 604 to voice biometric 612. In response to receiving a credentials valid signal 610 indicating that the user name “msmith” is valid, voice verification server 114 may receive/retrieve a voice biometric 612 associated with Mike Smith's user account (e.g., a voiceprint for Mike Smith), and compare one or more characteristics of candidate voice stream 604 (e.g., the audio data including the recording of “chocolate” as spoken by Mike Smith) to voice biometric 612.

In some embodiments, a voice biometric 612 that is used to verify/validate candidate voice stream 604 is provided by credential verification server 112. For example, upon determining that the user name “msmith” is valid, credential verification server 112 may retrieve a voice biometric 612 associated with Mike Smith's user account (e.g., a voiceprint for Mike Smith) from biometric database 118, and transmit the voice biometric 612 to voice verification server 114 (e.g., in addition to or in place of credential valid signal 610). Where only voice biometric 612 is transmitted to voice verification server 114, the voice biometric may act as the credential valid signal 610. That is, voice verification server 114 may proceed with verifying/validating candidate voice stream 604 in response to receiving voice biometric 612 from credential verification server 112.

In some embodiments, a voice biometric 612 that is used to verify/validate candidate voice stream 604 is retrieved by voice verification server 114. For example, in response to receiving credential valid signal 610 indicating that the user name “msmith” is valid, voice verification server 114 may retrieve the voice biometric 612 associated with Mike Smith's user account (e.g., the voiceprint for Mike Smith) from biometric database 118.

The verifying/validating process for candidate voice stream 604 may include comparing the content of the voice stream (e.g., what was said) and/or the biometric characteristics of the voice stream (e.g., how it was said). In some embodiments, candidate voice stream 604 is verified/validated when the content and/or the biometric characteristics of candidate voice stream 604 are verified/validated. For example, candidate voice stream 604 may be verified/validated if existing voice biometric 612 and candidate voice stream 604 both include a recording of Mike Smith saying the word “chocolate” in a similar manner. In contrast, candidate voice stream 604 may not be verified/validated if existing voice biometric 612 includes, or is based on, a recording of Mike Smith saying the word “chocolate” and candidate voice stream 604 includes a recording of Mike Smith saying the word “chocolate” in a different manner (e.g., in a different tone of voice), a recording of Mike Smith saying a word other than “chocolate” (e.g., Mike Smith saying “strawberry”), or a recording of another user's voice (e.g., Jane White saying the word “chocolate”). Thus, in some embodiments, the user's voice stream may be identified when the comparison reveals that the voice stream is spoken by the user associated with the user account and/or it includes the correct word/phrase/sound.

In some embodiments, the comparison of a candidate voice stream to an existing voice biometric is provided using a voice biometric engine. A voice biometric engine may be employed by voice verification server 114. For example, voice verification module 410 may include a voice biometric engine.

A voice biometric engine may include a collection of software functions that processes audio samples, extracts relevant vocal information (or features), and creates a unique and representative model of the original speech. During an enrollment process, a voice biometric engine may extract vocal features from one or more speech samples (e.g., existing voice streams) to create a voiceprint. During a verification process, the voice biometric engine may extract vocal features from a sample (e.g., the candidate voice stream), compare the features to a stored voiceprint, and then generate a score or match probability. If the score or match probability satisfies (e.g., meets or exceeds) a predetermined threshold, the identity of the speaker may be verified. If the score or match probability does not satisfy (e.g., is below) a predetermined threshold, the identity of the speaker may not be verified. For example, if the comparison of a candidate voice stream 604 to a voice biometric 612 associated with Mike Smith results in a score above a threshold of 80% (e.g., a score of 95%), the voice biometric engine may confirm that the speaker is in fact Mike Smith and, thus, the candidate voice stream 604 may be verified/validated.

If candidate voice stream 604 is not validated/verified, voice verification server 114 may provide a corresponding indication that candidate voice stream 604 is invalid (and/or that the user is not authenticated). In some embodiments, in response to voice verification server 114 determining that candidate voice stream 604 is invalid, voice verification server 114 transmits a voice stream invalid signal 614a (and/or an authentication status signal 616 indicating the user is not authenticated) to user device 104. For example, in response to voice verification server 114 determining that voice stream 604 includes the word “strawberry” (as opposed to “chocolate”) and/or is spoken by a person other than Mike Smith, voice verification server 114 may transmit a corresponding voice stream invalid signal 614a (and/or an authentication status signal 616 indicating the user is not authenticated) to user device 104. Voice stream invalid signal 614a may indicate that voice stream 604 is not verified/valid and, thus, the user is not authenticated.

In response to receiving voice stream invalid signal 614a (and/or an authentication status signal 616 indicating the user is not authenticated) user device 104 may continue to deny access to the resource and provide a corresponding notification to user 120. For example, in response to receiving voice stream invalid signal 614a (and/or an authentication status signal 616 indicating the user is not authenticated), user device 104 may continue to deny access to “report.doc”, and may display a notification that access was denied along with a prompt for the user to re-enter a valid user name and speak a valid password into a microphone of user device 104.

If candidate voice stream 604 is validated/verified, voice verification server 114 may provide a corresponding indication that candidate voice stream 604 is valid (and/or that the user is authenticated). In some embodiments, in response to voice verification server 114 determining that candidate voice stream 604 is valid, voice verification server 114 transmits a voice stream valid signal 614b (and/or an authentication status signal 616 indicating the user is not authenticated) to user device 104. For example, in response to voice verification server 114 determining that voice stream 604 includes the word “chocolate” (i.e., the password previously provided by Mike Smith during an enrollment process) and that it was spoken by Mike Smith, voice verification server 114 may transmit a corresponding voice stream valid signal 614b (and/or an authentication status signal 616 indicating the user is authenticated) to user device 104.

In response to receiving voice stream valid signal 614b (and/or an authentication status signal 616 indicating the user is authenticated) user device 104 may proceed with providing access to the resource. For example, in response to receiving voice stream valid signal 614b (and/or an authentication status signal 616 indicating the user is authenticated), user device 104 may retrieve “report.doc” from a document server 110 and display the document on user device 104 for review/editing. In some embodiments, providing access to a resource may include transmitting a resource request 618 to a resource server 110, and the resource server serving the requested resource 620.

FIGS. 8A-12 are flowcharts that illustrate various processes that may be involved in authenticating a user using voice biometrics and providing access to a resource. FIGS. 8A and 8B are flowchart that illustrates methods 800 and 850 of processing a resource request in accordance with one or more embodiments of the present invention. In some embodiments, some of all of the operational aspects of methods 800 and 850 are performed by a user device 104. For example, some or all of the operational aspects of methods 800 and 850 may be performed by access request module 210a and resource request module 210b, respectively.

FIG. 9 is a flowchart that illustrates a method of credential verification/validation 900 in accordance with one or more embodiments of the present invention. In some embodiments, some of all of the operational aspects of method 900 are performed by credential verification server 112. For example, some or all of the operational aspects of method 900 may be performed by credential verification module 310.

FIG. 10 is a flowchart that illustrates a method of voice stream verification/validation 1000 in accordance with one or more embodiments of the present invention. In some embodiments, some of all of the operational aspects of method 1000 are performed by voice verification server 114. For example, some or all of the operational aspects of method 900 may be performed by voice verification module 410.

Turing now to FIG. 8A, method 800 may include requesting and receiving candidate credentials and a candidate voice stream (e.g., a candidate credentials dataset) from a user (blocks 802 and 804). In some embodiments, requesting user credentials includes requesting that a user provide candidate credentials 602 and a candidate voice stream 604. For example, in response to receiving Mike Smith's request to open an electronic document entitled “report.doc”, device 104 may display a prompt requesting Mike Smith to enter a user name (e.g., a candidate user credential) and “speak” his vocal password into a microphone 216 of user device 104 (e.g., to provide a candidate voice stream).

Candidate credentials 602 may include, for example, a user name, PIN, secret code or a similar identifier. In some embodiments, candidate credentials may be provide by a user physical entering the data (e.g., typing the data in using a keyboard, touch screen, keypad or the like), speaking the data into a voice recognition device (e.g., speaking the data into an interactive voice response/voice over Internet Protocol (IVR/VOIP) device), presenting a physical access token (e.g., swiping a magnetic strip of an ID/access card though a card reader or the like), and/or the like. Candidate credentials for the user Mike Smith may include his user name “msmith”. A candidate voice stream 604 may include, for example, audible data corresponding to word(s), phrase(s), or other sounds spoken by a user. A candidate voice stream 604 for the user Mike Smith may include audio data corresponding to him speaking his password “chocolate”. A candidate voice stream may include audio data that can be used to verify the identity of the user that provided the vice stream. For example, as described herein the audio data of a candidate voice stream (e.g., a candidate voiceprint) may be compared to biometric data for the user (e.g., a known/existing voiceprint for the user) to verify that the candidate voice stream was in fact spoken by the user and/or includes required content.

In some embodiments, user credentials 602 and voice stream 604 (e.g., a candidate credentials dataset 600) are received via an I/O interface user device 104. For example, user 120 may submit candidate credentials 602 using a keyboard, keypad, touchscreen, voice recognition devices, or the like of user device 104. Voice stream 604 may be provided by a user speaking into an audio recording device, such as microphone 216, of user device 104.

Method 800 may include transmitting the candidate credentials and the candidate voice stream (block 806). In some embodiments, transmitting the candidate credentials and the candidate voice stream includes user device 104 forwarding candidate credentials 602 and/or candidate voice stream 604 to one or more entities of system 100 for use in authenticating the user. For example, user device 104 may forward candidate credentials 602 to credential verification server 112 and/or forward candidate voice stream 604 to voice verification server 114. User device 104 may, for example, forward the string “msmith” to credential verification server 112 for verification/validation, and/or forward candidate voice stream 604 including the recording of “chocolate” (as spoken by Mike Smith) to voice verification server 114 for verification/validation.

Turning now to FIG. 9, method 900 may include receiving candidate credentials (block 902). In some embodiments, receiving candidate credentials includes credential verification server 112 receiving candidate credentials 602 from user device 104. For example, credential verification server 112 may receive the string “msmith” from user device 104.

Method 900 may include determining whether the candidate credentials are valid (i.e., verifying/validating the candidate credentials) (block 904). Determining whether the candidate credentials are valid may include credential verification server 112 comparing candidate credentials 602 to existing credentials 606. For example, where credentials database 116 includes a listing of all existing/active user credentials, credential verification server 112 may query credentials database 116 for a listing of all existing user credentials 606, and may determine whether candidate credentials 602 matches an existing user credentials 606. Credential verification server 112 may, for example, retrieve a list of user names associated with current/active user accounts from credentials database 116, and determine whether the candidate user name “msmith” matches an existing user name associated with a current/active user account. The candidate credentials may be verified/validated if the candidate credentials matches an existing credential. For example, the candidate user name “msmith” may be verified/validated if the user name “msmith” is associated with a current/active user account (e.g., Mike Smith's user account). Candidate credentials 602 may not be verified/validated if the candidate credentials does not match an existing credential. For example, the candidate user name “msmith” may not be verified/validated if the user name “msmith” is not associated with a current/active user account (e.g., a user account for Mike Smith's does not exists or is de-activated).

If candidate credentials 602 are not validated/verified a corresponding indication that candidate credentials 602 are invalid may be provided (block 906). In some embodiments, in response credential verification server 112 determining that candidate credentials 602 are invalid, credential verification server 112 transmits a credential invalid signal 608 to user device 104. For example, in response to credential verification server 112 determining that the user name “msmith” is invalid, credential verification server 112 may transmit a corresponding credentials invalid signal 608 to user device 104. Credentials invalid signal 608 may indicate that candidate credentials 602 are not verified/valid and, thus, the user is not authenticated.

If candidate credentials 602 are validated/verified, a corresponding indication that candidate credentials 602 are verified/valid may be provided (block 908). In some embodiments, in response credential verification server 112 determining that candidate credentials 602 are verified/valid, credential verification server 112 transmits a credential valid signal 610 to voice verification server 114. For example, in response to credential verification server 112 determining that the user name “msmith” is verified/valid, credential verification server 112 may transmit a corresponding credentials valid signal 610 to voice verification server 114. Credentials valid signal 610 may indicate that candidate credentials 602 are verified/valid.

Turning now to FIG. 10, method 1000 may include receiving a candidate voice stream (block 1002). In some embodiments, receiving a candidate voice stream includes voice verification server 114 receiving candidate voice stream 604 transmitted by user device 104. For example, voice verification server 114 may receive the recording of “chocolate” (as spoken by Mike Smith) from user device 104.

Method 1000 may include determining whether the candidate voice stream is valid (i.e., verifying/validating the voice stream) (block 1004). In some embodiments, verifying/validating the voice stream is provided in response to candidate credentials 602 being verified/validated. For example, voice verification server 114 may proceed to verifying/validating candidate voice stream 604 in response to receiving credentials valid signal 610. Accordingly, in some embodiments, the authentication process may proceed to verifying/validating candidate voice stream 604 only after verifying/validating candidate credentials 602.

In some embodiments, verifying/validating candidate voice stream 604 includes comparing candidate voice stream 604 to an existing voice biometric 612 associated with the verified/validated candidate credentials 602. For example, voice verification server 114 may receive/retrieve a voice biometric 612 corresponding to the verified/validated candidate credentials 602, and compare one or more characteristics of candidate voice stream 604 to voice biometric 612. In response to receiving a credentials valid signal 610 indicating that the user name “msmith” is valid, voice verification server 114 may receive/retrieve a voice biometric 612 associated with Mike Smith's user account (e.g., a voiceprint for Mike Smith), and compare one or more characteristics of candidate voice stream 604 (e.g., the audio data including the recording of “chocolate” as spoken by Mike Smith) to voice biometric 612.

In some embodiments, a voice biometric 612 that is used to verify/validate candidate voice stream 604 is provided by credential verification server 112. For example, upon determining that the user name “msmith” is valid, credential verification server 112 may retrieve a voice biometric 612 associated with Mike Smith's user account (e.g., a voiceprint for Mike Smith) from biometric database 118, and transmit the voice biometric 612 to voice verification server 114 (e.g., in addition to or in place of credential valid signal 610). Where only voice biometric 612 is transmitted to voice verification server 114, the voice biometric may act as the credential valid signal 610. That is, in some embodiments, voice verification server 114 may proceed with verifying/validating candidate voice stream 604 in response to receiving voice biometric 612 from credential verification server 112.

In some embodiments, a voice biometric 612 that is used to verify/validate candidate voice stream 604 is retrieved by voice verification server 114. For example, in response to receiving credential valid signal 610 indicating that the user name “msmith” is valid, voice verification server 114 may retrieve the voice biometric 612 associated with Mike Smith's user account (e.g., the voiceprint for Mike Smith) from biometric database 118.

The verifying/validating process for candidate voice stream 604 may include comparing content of the voice stream (e.g., what was said) and/or the biometric characteristics of the voice stream (e.g., how it was said). In some embodiments, candidate voice stream 604 is verified/validated when the content and/or the biometric characteristics of candidate voice stream 604 are verified/validated. For example, candidate voice stream 604 may be verified/validated if existing voice biometric 612 and candidate voice stream 604 both correspond to a recording of Mike Smith saying the word “chocolate” in a similar manner. In contrast, candidate voice stream 604 may not be verified/validated if existing voice biometric 612 includes a recording of Mike Smith saying the word “chocolate” and candidate voice stream 604 includes a recording of Mike Smith saying the word “chocolate” in a different manner (e.g., in a different tone of voice), a recording of Mike Smith saying a word other than “chocolate” (e.g., Mike Smith saying “strawberry”), or a recording of another user's voice (e.g., Jane White saying the word “chocolate”).

In some embodiments, the comparison of a candidate voice stream to an existing voice biometric is provided using a voice biometric engine. A voice biometric engine may be employed by voice verification server 114. For example, voice verification module 410 may include a voice biometric engine. During a verification process, the voice biometric engine may extract vocal features from a sample (e.g., the candidate voice stream), compare the features to a stored voiceprint, and then generate a score or match probability. If the score or match probability satisfies (e.g., meets or exceeds) a predetermined threshold, the identity of the speaker may be verified. If the score or match probability does not satisfy (e.g., is below) a predetermined threshold, the identity of the speaker may not be verified. For example, if the comparison of a candidate voice stream 604 to a voice biometric 612 associated with Mike Smith results in a score above a threshold of 80% (e.g., a score of 95%), the voice biometric engine may confirm that the speaker is in fact Mike Smith and, thus, the candidate voice stream 604 may be verified/validated.

If candidate voice stream 604 is not validated/verified, voice verification server 114 may provide a corresponding indication that candidate voice stream 604 is invalid (and/or that the user is not authenticated) (block 1006). In some embodiments, in response to voice verification server 114 determining that candidate voice stream 604 is invalid, voice verification server 114 transmits a voice stream invalid signal 614a (and/or an authentication status signal 616 indicating the user is not authenticated) to user device 104. For example, in response to voice verification server 114 determining that voice stream 604 includes the word “strawberry” (as opposed to “chocolate”) and/or is spoken by a person other than Mike Smith, voice verification server 114 may transmit a corresponding voice stream invalid signal 614a (and/or an authentication status signal 616 indicating the user is not authenticated) to user device 104. Voice stream invalid signal 614a may indicate that voice stream 604 is not verified/valid and, thus, the user is not authenticated.

If candidate voice stream 604 is validated/verified, voice verification server 114 may provide a corresponding indication that candidate voice stream 604 is valid (and/or that the user is authenticated) (block 1008). In some embodiments, in response to voice verification server 114 determining that candidate voice stream 604 is valid, voice verification server 114 transmits a voice stream valid signal 614b (and/or an authentication status signal 616 indicating the user is not authenticated) to user device 104. For example, in response to voice verification server 114 determining that voice stream 604 includes the word “chocolate” (i.e., the vocal password previously provided by Mike Smith during an enrollment process) and that it was spoken by Mike Smith, voice verification server 114 may transmit a corresponding voice stream valid signal 614b (and/or an authentication status signal 616 indicating the user is authenticated) to user device 104.

Turning now to FIG. 8B, method 850 may include receiving an authentication signal (block 852) and determining whether the user is authenticated (block 854). In some embodiments, an authentication signal may indicate whether the candidate credentials set 600 (e.g., candidate credentials 602 and/or candidate voice stream 604) have or have not been verified/validated and, thus, the user 120 has or has not been authenticated. In some embodiments, an authentication signal may include a credential invalid signal 608, a voice stream invalid/valid signal 614a/614b and/or an authentication status signal 616.

In response to receiving credentials invalid signal 608, a voice stream invalid signal 614a and/or an authentication status signal 616 indicating the user is not authenticated, access to the resource may be denied and a corresponding indication of the denied access may be provided (block 856) For example, in response to receiving credential invalid signal 608, a voice stream invalid signal 614a, and/or an authentication status signal 616 indicating the user is not authenticated, user device 104 may continue to deny access to “report.doc”, and may display a notification that access was denied along with a prompt for the user to re-enter a valid user name and speak a valid password into a microphone of user device 104.

In response to receiving voice stream valid signal 614b and/or an authentication status signal 616 indicating the user is authenticated, access to the resource may be provided (block 858). For example, in response to receiving voice stream valid signal 614b and/or an authentication status signal 616 indicating the user is authenticated, user device 104 may retrieve “report.doc” from a document server 110 and display the document on user device 104 for review/editing. In some embodiments, providing access to a resource may include transmitting a resource request 618 to a resource server 110, and resource server 110 retrieving the resource (e.g., a document) from a database 120, resource server 110 serving the requested resource 620 to user device 104, and user device 104 providing access to the resource (e.g., displaying a document). In some embodiments, providing access to a resource may include user device 104 providing access. For example, where the request includes a request to e-sign a document, providing access to the resource may include the user device allowing a user to access an application that allows the user to e-sing documents using an e-signature associated with the authenticated user. Where, for example, user device 104 includes an electronic lock (e.g., door lock 104d), providing access to the resource may include the lock opening to provide the user with physical access to an area or the like.

Accordingly, in some embodiments of the present invention, a user may be authenticated and/or provided access to a resource based on verification/validation of user credentials and/or a voice biometric provided by the user. Such an authentication technique may provide enhanced network security in an efficient and cost effective manner.

It will be appreciated that methods 800, 850, 900 and 1000 are exemplary embodiments of methods that may be employed in accordance with techniques described herein. The methods 800, 850, 900 and 1000 may be may be modified to facilitate variations of its implementations and uses. The order of the methods 800, 850, 900 and 1000 and the operations provided therein may be changed, and various elements may be added, reordered, combined, omitted, modified, etc. The methods 800, 850, 900 and 1000 may be implemented in software, hardware, or a combination thereof. Some or all of the methods 800, 850, 900 and 1000 may be implemented by one or more of the modules/applications described herein.

In some embodiments, some or all of methods 800, 850, 900 and 1000 may be may be implemented by one or more of the modules/applications described herein and/or may be executed on one or more devices. For example, credential verification module 310 and voice verification module 410 may be employed on a single authentication server.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A system for authenticating users using voice biometrics, the system comprising:
a user device configured to:
receive a request to access a resource;
receive a credentials set from a user, the credentials set comprising candidate credentials and a candidate voice stream;
transmit the candidate credentials to a credential verification server; and
transmit the candidate voice stream to a voice verification server;
the credential verification server configured to:
receive the candidate credentials;
determine whether the candidate credentials are valid based on a comparison of the candidate credentials to existing user credentials; and
in response to determining that the candidate credentials are valid, transmit a voice biometric associated with the candidate credentials to the voice verification server; and
the voice verification server configured to:
receive the candidate voice stream and the voice biometric;
determine whether the candidate voice stream is valid based on a comparison of the candidate voice stream to the voice biometric; and
in response to determining that the voice stream is valid, generate an authentication signal indicative of the user being authenticated,
wherein the user device is configured to provide access to the resource in response to the authentication signal.

2. The system of claim 1, wherein the credential verification server is further configured to:
in response to determining that the candidate credentials are invalid, transmit a credentials invalid signal to the user device, wherein the user device is configured to inhibit access to the resource based at least in part on the credentials invalid signal.

3. The system of claim 1, wherein the voice verification server is further configured to:
in response to determining that the candidate voice stream is invalid, transmit a voice stream invalid signal to the user device, wherein the user device is configured to inhibit access to the resource based at least in part on the voice stream invalid signal.

4. The system of claim 1, wherein the user device is further configured to:
prompt the user to provide enrollment credentials and speak a vocal password;
receive input of the enrollment credentials provided by the user; and
acquire the vocal password spoken by the user,
wherein the enrollment credentials are stored in a credentials database as credentials for a user account associate with the user,
wherein a voice biometric is generated based on the vocal password,
wherein the voice biometric is stored in a biometric database as a voice biometric for the user account associate with the user.

5. The system of claim 1, wherein the candidate credentials comprise a user identifier.

6. The system of claim 1, wherein a voice biometric for a user comprises a voiceprint based on a recording of the user's speech.

7. The system of claim 1, wherein the resource comprises an electronic document.

8. The system of claim 1, wherein the resource comprises access to a user device.

9. The system of claim 1, wherein the resource comprises access to an electronic signature function.

10. The system of claim 1, wherein the user device comprises and electronic lock and the resource comprises opening of the lock to provide physical access to a physical location.

11. A computer-implemented method for authenticating users using voice biometrics, the method comprising:
receiving a request to access a resource via a user device;
receiving a credentials set from a user, the credentials set comprising candidate credentials and candidate voice stream;
determining whether the candidate credentials are valid based on a comparison of the candidate credentials to existing user credentials;
in response to determining that the candidate credentials are valid, determining whether the candidate voice stream is valid based on a comparison of the candidate voice stream to a voice biometric associated with the candidate credentials; and
in response to determining that the candidate voice stream is valid, generating an authentication signal configured to enable access to the resource via the user device.

12. The method of claim 11, further comprising:
receiving a second request to access a resource via a user device;
receiving a second credentials set from a user, the second credentials set comprising second candidate credentials and a second candidate voice stream;
determining whether the second candidate credentials are valid based on a comparison of the second candidate credentials to existing user credentials;
in response to determining that the second candidate credentials are invalid, generating a not-authenticated signal, wherein the user device associated with the second request is configured to inhibit access to the resource associated with the second request based at least in part on the not-authenticated signal.

13. The method of claim 11, further comprising:
receiving a second request to access a resource via a user device;
receiving a second credentials set from a user, the second credentials set comprising second candidate credentials and a second candidate voice stream;
determining whether the second candidate voice stream is valid based on a comparison of the second candidate voice stream to a voice biometric associated with the second candidate credentials;
in response to determining that the second candidate voice stream is invalid, generating a not-authenticated signal, wherein the user device associated with the second request is configured to inhibit access to the resource associated with the second request based at least in part on the not-authenticated signal.

14. The method of claim 11, further comprising:
prompting the user to provide enrollment credentials and speak a vocal password;
receiving input of the enrollment credentials provided by the user;
acquiring the vocal password spoken by the user;
storing the enrollment credentials as credentials for a user account associate with the user;
generating a voice biometric based on the vocal password; and
storing the voice biometric as a voice biometric for the user account associate with the user.

15. The method of claim 11, wherein the candidate credentials comprise a user identifier.

16. The method of claim 11, wherein a voice biometric for a user comprises a voiceprint based on a recording of the user's speech.

17. The method of claim 11, wherein the resource comprises an electronic document.

18. The method of claim 11, wherein the resource comprises access to a user device.

19. The method of claim 11, wherein the resource comprises access to an electronic signature function.

20. The method of claim 11, wherein the user device comprises and electronic lock and the resource comprises opening of the lock to provide physical access to a physical location.

21. A non-transitory computer readable storage medium having program instructions stored thereon that are executable by one or more processors to cause the following steps for authenticating users using voice biometrics:
receiving a request to access a resource via a user device;
receiving a credentials set from a user, the credentials set comprising candidate credentials and candidate voice stream;
determining whether the candidate credentials valid based on a comparison of the candidate credentials to existing user credentials;
in response to determining that the candidate credentials are valid, determining whether the candidate voice stream is valid based on a comparison of the candidate voice stream to a voice biometric associated with the candidate credentials; and
in response to determining that the candidate voice stream is valid, generating an authentication signal configured to enable access to the resource via the user device.

22. The medium of claim 21, the steps further comprising:
receiving a second request to access a resource via a user device;
receiving a second credentials set from a user, the second credentials set comprising second candidate credentials and a second candidate voice stream;
determining whether the second candidate credentials are valid based on a comparison of the second candidate credentials to existing user credentials;
in response to determining that the second candidate credentials are invalid, generating a not-authenticated signal, wherein the user device associated with the second request is configured to inhibit access to the resource associated with the second request based at least in part on the not-authenticated signal.

23. The medium of claim 21, the steps further comprising:
receiving a second request to access a resource via a user device;
receiving a second credentials set from a user, the second credentials set comprising second candidate credentials and a second candidate voice stream;
determining whether the second candidate voice stream is valid based on a comparison of the second candidate voice stream to a voice biometric associated with the second candidate credentials;
in response to determining that the second candidate voice stream is invalid, generating a not-authenticated signal, wherein the user device associated with the second request is configured to inhibit access to the resource associated with the second request based at least in part on the not-authenticated signal.

24. The medium of claim 21, the steps further comprising:
prompting the user to provide enrollment credentials and speak a vocal password;
receiving input of the enrollment credentials provided by the user;
acquiring the vocal password spoken by the user;
storing the enrollment credentials as credentials for a user account associate with the user;
generating a voice biometric based on the vocal password; and
storing the voice biometric as a voice biometric for the user account associate with the user.

25. The medium of claim 21, wherein the candidate credentials comprise a user identifier.

26. The medium of claim 21, wherein a voice biometric for a user comprises a voiceprint based on a recording of the user's speech.

27. The medium of claim 21, wherein the resource comprises an electronic document.

28. The medium of claim 21, wherein the resource comprises access to a user device.

29. The medium of claim 21, wherein the resource comprises access to an electronic signature function.

30. The medium of claim 21, wherein the user device comprises and electronic lock and the resource comprises opening of the lock to provide physical access to a physical location.
